(19) United States
(12) Patent Application Publication
(10) Pub. No.: US 2026/0043563 A1
(43) Pub. Date: Feb. 12, 2026

(54) Water Anion Air Conditioner and Water Anion Excitation Device Thererof

(71) Applicant: Ya LI, Taizhou, Zhejiang (CN)

(72) Inventors: Ya Li, Taizhou City, Zhejiang Province (CN); Lijun Chen, Taizhou City, Zhejiang Province (CN); Gang Zhou, Taizhou City, Zhejiang Province (CN)

(21) Appl. No.: 19/139,857

(22) PCT Filed: Dec. 25, 2023
(86) PCT No.: PCT/CN2023/141575

§ 371 Date: Jun. 16, 2025

(30) Foreign Application Priority Data
Mar. 10, 2023 (CN) 202310228309.5

(51) Int. Cl. F24F 8/30; C02F 1/42; F24F 6/00

(52) U.S. Cl. CPC F24F 8/30; C02F 1/42; F24F 6/00; C02F 2001/422; F24F 2006/006

(57) ABSTRACT

A water anion air conditioner and a water anion excitation device thereof are disclosed, The water anion air conditioner comprises an air conditioner main body and the water anion excitation device which comprises an excitation mechanism and a water storage chamber, the excitation mechanism comprises an excitation unit and an elastic body. Liquid stored in the water storage chamber is adapted to be guided to the excitation unit, and when the excitation unit impacts the elastic body, the liquid and the excitation unit are caused to rub against each other so as to generate water anions. The water anions generated by the water anion excitation device are diffused for a long distance in an environment, thereby achieving the health care effect on human bodies within a large range.

### CROSS REFERENCE OF RELATED APPLICATION

This is a U.S. National Stage under 35 U.S.C. 371 of the International Application Number PCT/CN2023/141575, filed Dec. 25, 2023, which claims priority under 35 U.S.C. 119 (a-d) to Chinese application number CN202310228309.5, filed Mar. 10, 2023, wherein the afore-mentioned patent applications are hereby incorporated by reference in their entities.

### BACKGROUND OF THE PRESENT INVENTION

### Field of Invention

The present invention relates to the field of negative ion technology, and particularly to a water anion air conditioner and a water anion excitation device.

### Description of Related Arts

Negative ions refer to ions with one or more negative charges. Negative ions have a therapeutic and health-care effect. Studies have shown that the concentration of negative oxygen ions is positively correlated with human health. When there are more than 20,000 negative oxygen ions per cubic centimeter of air, it will have a health-care effect on the body. Negative ions also have an air optimization effect. Ecological-grade negative ions can actively capture small particles of dust, causing them to condense and precipitate, effectively removing dust from the air and having a sterilizing effect, thereby reducing the harm of dust or floating bacteria to human health.

The negative ions generated by the conventional negative ion generators on the market are negative air ions. Specifically, the negative ions are blown out by a fan by ionizing air molecules with high voltage direct current. However, such negative ion generators usually use a higher working voltage to generate more negative ions during operation. However, the high voltage will cause the negative ion generator to generate static electricity and ozone that are harmful to human health.

Air conditioners are devices that regulate and control parameters such as the temperature, humidity, and flow rate of ambient air. However, existing air conditioners do not yet have the function of generating negative ions.

### SUMMARY OF THE PRESENT INVENTION

In order to solve the above technical problems, the present invention provides a water anion excitation device comprising:
an excitation mechanism comprising an excitation unit and an elastic water absorbent body; and
a water storage chamber body, wherein the liquid stored in the water storage chamber body is suitable for being absorbed into the elastic water absorbent body, and the excitation unit is used to impact the elastic water absorbent body, so as to rub against the liquid in the elastic water absorbent body to generate water negative ions.

The present invention also provides a water anion excitation device comprising:
an excitation mechanism comprising an excitation unit and an elastic body; and
a water storage chamber body, wherein the liquid stored in the water storage chamber body is suitable for being guided to the excitation unit, and when the excitation unit impacts the elastic body, the excitation unit rubs against the liquid to generate water negative ions.

Preferably, the excitation mechanism further comprises a housing, wherein the housing has an accommodating channel which is communicated to the water storage chamber body, wherein the elastic water absorbing body is arranged in the accommodating channel.

Preferably, the housing further has a guide channel, which is communicated to the accommodating channel, wherein the accommodating channel is extended transversely from the guide channel and is communicated to the water storage chamber body through the guide channel.

Preferably, the water anion excitation device further has a buffer channel formed between the accommodating channel and the guide channel.

Preferably, an inner diameter of the buffer channel is smaller than an inner diameter of the accommodating channel, so as to prevent the elastic water absorbent body from entering the buffer channel.

Preferably, the water anion excitation device also comprises a casing which comprises a liquid storage tank below the excitation mechanism, and the excitation mechanism also comprises a recovery liquid excitation unit and a recovery liquid elastic water absorbent body, wherein when there is liquid in the liquid storage tank, the liquid will be absorbed into the recovery liquid elastic water absorbent body, and the recovery liquid excitation unit acts on a side of the recovery liquid elastic water absorbent body to generate water negative ions.

Preferably, the water anion excitation device further comprises an air blowing mechanism which comprises a fan to blow air toward the exciting mechanism.

Preferably, the water anion excitation device further comprises a casing, wherein the casing has an outlet on a surrounding side, and the fan blows air toward the outlet to carry the water negative ions generated by the excitation mechanism to migrate to an outside of the water anion excitation device.

Preferably, the air blowing mechanism further comprises an air filter layer to filter the air before sending the air to the excitation mechanism by the fan.

Preferably, the elastic water absorbent body is a cotton column.

Preferably, the excitation unit comprises a piezoelectric piece and an impact piece located on the piezoelectric piece, wherein the impact piece has micropores in a central region, and a pore size of the micropores is less than 10 μm.

Preferably, the impact piece has a diameter of 10-20 mm, the central region having the micropores has a diameter of 1-10 mm, the number of the micropores is 500-5000, and the pore size of the micropores is less than 5 μm.

Preferably, the impact piece is made of a material that loses charge more easily than water.

Preferably, the impact piece is formed from a metal alloy.

Preferably, the excitation unit is loaded with a voltage having a frequency of 3 KHz-5 MHz and a peak value of 60V-90V.

Preferably, the excitation unit further comprises a guide chamber body arranged outside the impact piece, wherein the guide chamber body forms a conical guide chamber.

Preferably, the excitation mechanism comprises a plurality of the excitation units arranged along a circumferential direction and provided on the housing, wherein a gap is formed in a middle area of the housing so that the wind generated by the fan can blow toward the gap.

Preferably, the elastic body is elastic silicon or elastic rubber.

Preferably, the elastic body has an inner cavity, the excitation unit is arranged in the inner cavity, and when the excitation unit is driven to vibrate, the excitation unit impacts the elastic body and provides buffering through the elastic body.

Preferably, the excitation unit comprises a piezoelectric piece and an impact piece located on the piezoelectric piece, wherein the impact piece has micropores in the central region, and the pore size of the micropores is less than 10 μm.

Preferably, the excitation unit comprises two piezoelectric pieces and an impact piece located between the two piezoelectric pieces, wherein the impact piece has micropores in a central region, and a diameter of the micropores is less than 10 μm.

Preferably, the elastic body comprises an annular fixing plate, a buffering body and a connecting body, the buffering body is integrally extended inwardly through the connecting body to the annular fixing plate, and the buffering body contacts the central area of the impact piece having the plurality of micropores.

Preferably, the elastic body comprises an annular fixing plate, a buffering body and a connector, the buffering body extends inwardly and integrally through the connector to the annular fixing plate, the excitation unit forms a groove at a position adjacent to the buffering body, the buffering body comprises a protrusion extending into the groove, and the protrusion corresponds to and contacts the central area of the impact piece having a plurality of the micropores.

Preferably, the central areas of the buffering body and the impact piece correspond in shape and are circular.

Preferably, the excitation unit further comprises a guide chamber body arranged outside the impact piece, and the impact piece is arranged between the guide chamber body and the elastic body.

Preferably, the excitation mechanism has one or more mounting grooves on a side thereof, the elastic body is installed in the corresponding mounting groove, and each of the excitation units is correspondingly sealed and installed in the elastic body and located in the mounting groove.

Preferably, an electron charging device is employed to charge a negative ion water mist generated by the excitation mechanism to increase the concentration of negative ions in the negative ion water mist.

The present invention also provides a method for generating water negative ions comprising the steps of:
(a) allowing the liquid in a liquid storage chamber body to be absorbed into an elastic water absorbent body; and
(b) driving the impact piece having micropores to reciprocately impact the elastic water absorbent body to generate micro water droplets, and the micro water droplets are rubbed against the impact piece to obtain negative ions to generate water negative ions.

Preferably, the liquid in the liquid storage chamber body is introduced into the elastic water absorbent body disposed in an accommodating channel through a guide channel.

Preferably, a buffer channel is provided between the accommodating channel and the guide channel, and the buffer channel and the accommodating channel extend horizontally and transversely to the guide channel in a vertical direction.

The present invention also provides an excitation mechanism for a water anion excitation device comprising a water storage chamber body, wherein the excitation mechanism comprises:
an excitation unit and an elastic body, wherein the liquid stored in the water storage chamber body is suitable for being guided to the excitation unit, and when the excitation unit impacts the elastic body, the liquid rubs against the excitation unit to generate water negative ions.

The present invention also provides a water anion air conditioner which comprises an air conditioner main body and the water anion excitation device mentioned above.

The present invention has the following beneficial effects.

(1) The elastic water absorbent body is impacted by the impact piece of an excitation mechanism to make the water in the elastic water absorbent body resonate to generate water negative ions. Compared with generating air negative ions through high-voltage ionization, the water anion excitation device of the present invention avoids generating static electricity and ozone.

(2) The excitation mechanism simulates the impact of a waterfall to generate water anions such as H+ negative water molecule group [H₃O₂—(H₂O)n], HO− negative water molecule group OH—(H₂O) n, negative water molecule —(H₂O) n, etc., so that the generated water anions are more beneficial to the health care of the human body.

(3) The excitation mechanism vibrates water at a high frequency to vaporize and generate tiny droplets, and causes the tiny droplets to rub at a high frequency between the elastic water absorbent body and the impact piece of the excitation mechanism so that the tiny droplets are charged to form water anions that are beneficial to human health.

(4) The excitation mechanism can simultaneously complete the process of generating tiny droplets from liquid water and charging the tiny droplets, thereby efficiently generating water negative ions.

(5) The size of vaporized tiny droplets can be controlled by the micropores of the impact piece of the excitation mechanism, and the size of the micropores is extremely small so that a high amount of water anions is generated when the impact piece vibrates at a high frequency.

(6) The elastic water absorbent body can control the flow of water and the excitation sheet can impact the elastic water absorbent body to reduce noise during operation.

(7) The condensed water or overflowed water in the water anion excitation device can be recycled to generate water negative ions.

(8) The negative water ions generated by the water anion excitation device diffuse over a long distance in the environment, thereby being able to play a role in recuperation and health care for the human body in a relatively large range.

(9) The water anion excitation device can release water negative ions into the environment when adjusting and controlling parameters such as temperature, humidity, flow rate, etc. in the environment, thereby purifying the ambient air and playing a medical protective role for the human body.

(10) The excitation unit is embedded with elastic silicon or elastic rubber, thereby reducing the noise of the excitation unit when it is working and preventing bubbles from being blocked in the water channel.

(11) The negative ion water mist is generated by the water anion excitation device and charged by the electron charging device so that the negative ion water mist is charged to saturate the charge to generate water negative ions that are beneficial to human health and purify the air.

### BRIEF DESCRIPTION OF THE DRAWINGS

FIG. 1 is a perspective view of a water anion air conditioner according to a preferred embodiment of the present invention.

FIG. 2 is an exploded view of the water anion excitation device of the water anion air conditioner of the above preferred embodiment of the present invention.

FIG. 3 is a sectional view of the water anion excitation device of the above preferred embodiment of the present invention.

FIG. 4 is a schematic view of the structure of the impact piece and the piezoelectric piece of the excitation mechanism of the negative ion excitation device of the above preferred embodiment of the present invention.

FIG. 5 is a perspective view of a water anion excitation device according to another preferred embodiment of the present invention.

FIG. 6 is an exploded view of the water anion excitation device according to the another preferred embodiment of the present invention.

FIG. 7 is a sectional view of the water anion excitation device according to the another preferred embodiment of the present invention.

FIG. 8 is a schematic view illustrating the structure of the liquid storage chamber body and the excitation mechanism of the water anion excitation device according to the another preferred embodiment of the present invention.

FIG. 9 is a sectional view illustrating the liquid storage chamber body and the excitation mechanism of the water anion excitation device according to the another preferred embodiment of the present invention.

FIG. 10 is a partially enlarged view of the excitation unit and the elastic body of the water anion excitation device according to the another preferred embodiment of the present invention.

FIG. 11 is a partially enlarged exploded view of the excitation unit and the elastic body of the water anion excitation device according to the another preferred embodiment of the present invention.

FIG. 12 is a partially enlarged sectional view of the excitation unit and the elastic body of the water anion excitation device according to the another preferred embodiment of the present invention.

FIG. 13 is a partially enlarged view of the excitation unit and the elastic body of the water anion excitation device according to the another preferred embodiment of the present invention.

FIG. 14 is a partially enlarged exploded view of the excitation unit and the elastic body of the water anion excitation device according to the another preferred embodiment of the present invention.

FIG. 15 is a partially enlarged further exploded view of the excitation unit and the elastic body of the water anion excitation device according to the another preferred embodiment of the present invention.

FIG. 16 is a partially enlarged sectional view of the excitation unit and the elastic body of the water anion excitation device according to the another preferred embodiment of the present invention.

### DETAILED DESCRIPTION OF THE PREFERRED EMBODIMENT

The terms and words used in the following description are not limited to the literal meanings, but are used only by the inventor to enable a clear and consistent understanding of the present application. Therefore, it is obvious to those skilled in the art that the following description of various embodiments of the present application is provided for the purpose of illustration only and not for the purpose of limiting the present application as defined by the attached claims and their equivalents.

Although ordinals such as “first,” “second,” and the like will be used to describe various components, those components are not limited herein. The term is used only to distinguish one component from another. For example, a first component may be referred to as a second component, and likewise, a second component may be referred to as a first component without departing from the teachings of the inventive concept. The term “and/or” as used herein comprises any and all combinations of one or more associated listed items.

The terms used herein are only used for the purpose of describing various embodiments and are not intended to be limiting. As used herein, singular forms are intended to also comprise plural forms, unless the context clearly indicates an exception. In addition, it will be understood that the terms “including” and/or “having” when used in this specification specify the presence of the described features, numbers, steps, operations, components, elements or combinations thereof, without excluding the presence or addition of one or more other features, numbers, steps, operations, components, elements or groups thereof.

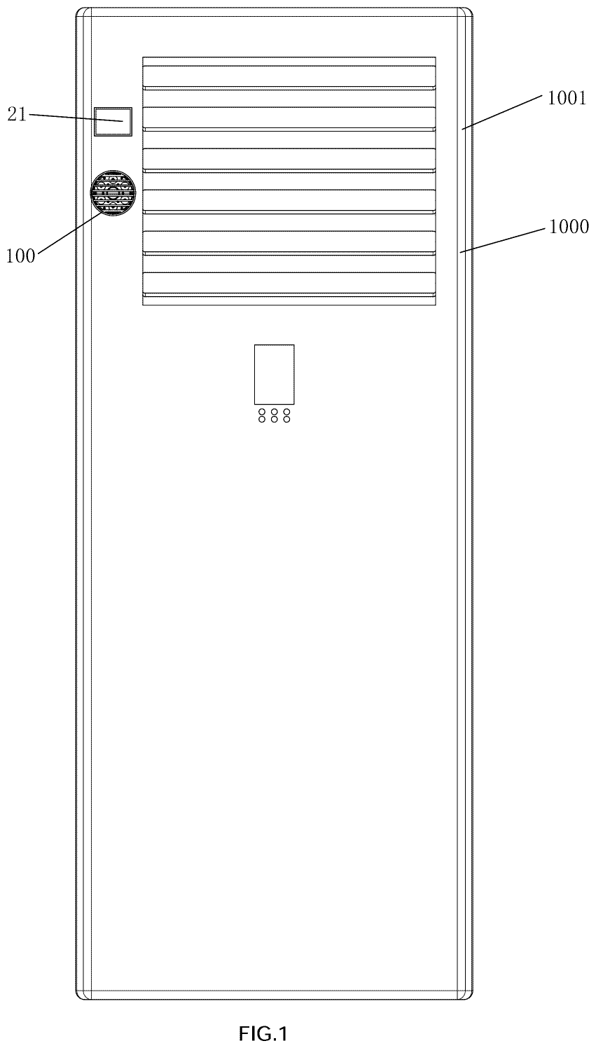

As shown in FIGS. 1 to 4, a water anion air conditioner 1000 and a water anion excitation device 100 according to a preferred embodiment of the present invention are shown. The water anion excitation device 100 comprises an exciting mechanism 10, a liquid storage chamber body 20 and an air blowing mechanism 30, wherein the liquid storage chamber body 20 is used to store liquid such as water, and the liquid storage chamber body 20 supplies liquid to the exciting mechanism 10 after being filled with water through a water feeding port 21 so that the liquid generates water negative ions when the exciting mechanism 10 is working, and the air blowing mechanism 30 blows the water negative ions generated by the exciting mechanism 10 to the outside of the water anion excitation device so that the water negative ions migrate and diffuse into the environment.

The water anion air conditioner 1000 comprises an air conditioner main body 100 and the water anion excitation device 100, and the water anion excitation device 100 is installed on the air conditioner main body 1001 to increase the function of providing water negative ions to the water anion air conditioner 1000. The air conditioner main body 1001 has a common air conditioner structure, which may comprise structures such as a box, a refrigeration system and/or a heating system, an air duct system, a humidification system, an electrical system, etc., so that the air conditioner can operate normally. It is understandable that the air conditioner main body 1001 can be a central air conditioner, an indoor wall-mounted air conditioner, a vertical air conditioner, a car air conditioner, etc.

It is understandable that the water anion excitation device 100 can be used alone without being assembled in the water anion air conditioner 1000, or can be assembled in other air purification equipment such as vehicle-mounted purification equipment, fresh air system, etc.

The excitation mechanism 10 comprises one or more excitation units 11, one or more elastic bodies implemented as elastic water absorbent bodies 12, a housing 13, a power supply and a controller, wherein the housing 13 forms one or more accommodating channels 131 for accommodating the corresponding one or more elastic water absorbent bodies 12, and the accommodating channels 131 are communicated to the liquid storage chamber body 20, so that the liquid in the liquid storage chamber body 20 can enter the elastic water absorbent body 12, each of the elastic water absorbent bodies 12 has an action end 121, and is aligned with one of the excitation units 11, wherein when the corresponding excitation unit 11 is electrically connected to the controller and driven under the power supply, the excitation unit 11 can vibrate reciprocatingly at a high frequency to impact the action end 121 of the corresponding elastic water absorbent body 12, so that the liquid in the action end 121 of the elastic water absorbent body 12 resonates and vaporizes to generate tiny droplets, and the tiny droplets rub against the excitation unit 11 between the action end 121 of the elastic water absorbent body 12 and the excitation unit 11 to generate tiny droplets with electric charge, so as to generate water negative ions.

The excitation unit 11 comprises an impact piece 111 and a piezoelectric piece 112 attached to and electrically connected to the impact piece 111, wherein the piezoelectric piece 112 and the impact piece 111 are electrically connected to the controller and are powered and driven by the power supply, and the piezoelectric piece 112 and the impact piece 111 can be electrically connected to the controller respectively through two wires. Alternatively, the piezoelectric piece 112 can be electrically connected to the controller through two wires. More specifically, the impact piece 111 has a central area 1111 and an outer circumferential area 1112, wherein the piezoelectric piece 112 is a piezoelectric ceramic and is annular, which is attached to the outer circumferential area 1112 of the impact piece 111, and the central area 1111 of the impact piece 111 has a plurality of micropores 1113 to form a mesh structure.

The impact piece 111 is used to vibrate and impact the corresponding action end 121 of the elastic water absorbent body 12 to generate water anions. More specifically, when a voltage of a predetermined frequency and peak value is applied to the piezoelectric piece 112 and the impact piece 111, the impact piece 111 will generate high-frequency vibration and hit the elastic water absorbent body 12, so that the water infiltrated into the elastic water absorbent body 12 resonates to generate tiny droplets, and the tiny droplets are rubbed with the impact piece 111 at a high frequency between the impact piece 111 and the elastic water absorbent body 12 at the same time, so that the tiny droplets are further negatively charged to form water anions and diffuse from the micropores 1113 to the environment. The air blowing mechanism 30 blows out wind and carries the water anions released from the micropores 1113 to diffuse to the external environment to increase the migration distance of the water anions.

Correspondingly, when the impact piece 111 is driven by the piezoelectric piece 112 to reciprocate, it simultaneously completes two processes to generate water negative ions, namely, gasifying the liquid that has penetrated into the action end 121 of the elastic water absorbent body 12 and charging the gasified liquid to efficiently generate water negative ions. In the present invention, when the excitation unit 11 vibrates at a high frequency, the water molecules that have penetrated into the action end 121 of the elastic water absorbent body 12 are driven to resonate at the same frequency and gasify to generate tiny droplets. At the same time, the generated tiny droplets rub against the high-frequency vibrating impact piece 111, so that the impact piece 111 loses its charge and the tiny droplets gain charge. The gasified tiny droplets that gain charge thus form water negative ions such as negative water molecule groups containing H+: [H₃O₂—(H₂O) n], negative water molecule groups containing HO−: OH—(H₂O) n, negative water molecules containing —(H₂O)n, etc.

In this embodiment of the present invention, the elastic water absorbent body 12 is made of a flexible material that allows water to penetrate, such as a cotton column filled into the accommodating channel 131, which has water-absorbing properties and a certain elasticity to withstand the impact of the impact piece 111, and the impact piece 111 does not directly impact the liquid but vibrates the droplets that penetrate into the elastic water absorbent body 12, so that these droplets are efficiently and quickly converted into tiny droplets, and the elastic water absorbent body 12 can reduce the noise generated during vibration and impact.

The housing 13 further comprises one or more guide channels 132, which are communicated to the liquid storage chamber body 20, wherein each of the accommodating channels 131 is communicated to the corresponding guide channel 132, and the accommodating channels 131 is extended transversely from the corresponding guide channel 132, wherein each of the elastic water-absorbing bodies 12 is filled into the accommodating channels 131 to be consistent with the extension direction of the accommodating channels 131. For example, in this embodiment, each of the guide channels 132 is arranged in a vertical direction, and each of the accommodating channels 131 and the corresponding elastic water absorbent body 12 are arranged in a horizontal direction, and the lengths of the elastic water absorbent body 12 and the accommodating channels 131 are substantially equal.

In this embodiment, the length of the elastic water absorbent body 12 is slightly smaller than the length of the accommodating channel 131, so that a buffer channel 133 is formed between the accommodating channel 131 and the guide channel 132. The liquid storage chamber 10 is located above the excitation unit 11, and the liquid naturally enters each of the guide channels 132 from the liquid storage chamber body 20 due to gravity and further flows into the buffer channel 133 to be buffered in the buffer channel 133. A water-absorbing end 122 of the elastic water absorbent body 12 is used to absorb the liquid in the buffer channel 133 into the elastic water absorbent body 12, and the elastic water absorbent body 12 controls the flow of the liquid entering the accommodating channel 131, so that an appropriate amount of liquid reaches the action end 121 of the elastic water absorbent body 12, so that the impact piece 111 can impact and efficiently generate water negative ions.

It can be understood that the elastic water absorbent body 12 is filled into the accommodating channel 131 and is held in the accommodating channel 131 by friction, and will not be displaced significantly and detached under the impact of the impact piece 111. In this embodiment, the diameter of the accommodating channel 131 is larger, and the buffer channel 133 has a smaller diameter, so that after the elastic water absorbent body 12 is filled into the accommodating channel 131, its size is also larger relative to the buffer channel 133, so that it is held in the accommodating channel 131 and will not be displaced significantly, that is, the inner wall of the buffer channel 133 is formed to block the further movement of the elastic water absorbent body 12.

In this embodiment, the excitation mechanism 10 comprises a plurality of the excitation units 11, and the housing 13 is formed with the guide channels 132 and the accommodating channels 131 which are communicated to each other. These excitation units 11 can work simultaneously or alternately in batches and periodically, thereby saving power and preventing the excitation units 11 from being damaged due to long-term continuous operation.

The negative ion excitation device 100 of the present invention further comprises a casing 40, wherein the casing 40 has an outlet 41 on a surrounding peripheral side, the excitation mechanism 10 and the blowing mechanism 30 are arranged in the casing 40, and the liquid storage chamber body 20 is integrally formed in the casing 40 or is a water storage container installed in the casing 40. The casing 40 also comprises a liquid storage tank 42 below the excitation mechanism 10 to accommodate condensed water or liquid overflowing from the liquid storage chamber body 20.

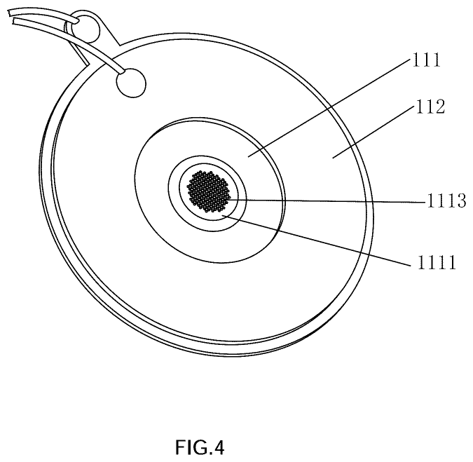

As shown in FIGS. 4, one of the excitation units 11 in the excitation mechanism 10, such as the excitation unit 11 on the bottom side, is implemented as a recovery liquid excitation unit 11′, which comprises an impact piece 111′ and a piezoelectric piece 112′ attached to and electrically connected to the impact piece 111′, and the housing 13 comprises an accommodating channel extending in the vertical direction, and the excitation mechanism 10 comprises a recovery liquid elastic water absorbent body 12′, which is filled into the accommodating channel extending in the vertical direction, and its water absorption end 122′ extends into the liquid storage tank 42, and the active end 121′ at the other end extends in the vertical direction to the position corresponding to the impact piece 111′, and the vertex of its active end 121′ is higher than the height of the vertex of the impact piece 111′.

That is to say, when there is liquid in the liquid storage tank 42, the liquid will be sucked into the recovery liquid elastic water absorbent body 12′ by the water absorption end 122′ of the recovery liquid elastic water absorbent body 12′ and the liquid will be fed to the action end 121′. When the impact piece 111′ is driven by the piezoelectric piece to vibrate at a high frequency, the impact piece 111′ hits the side of the action end 121′ to generate water negative ions. In this way, the liquid will not accumulate in the liquid storage tank 42, but will serve as an additional water source in the excitation mechanism 10.

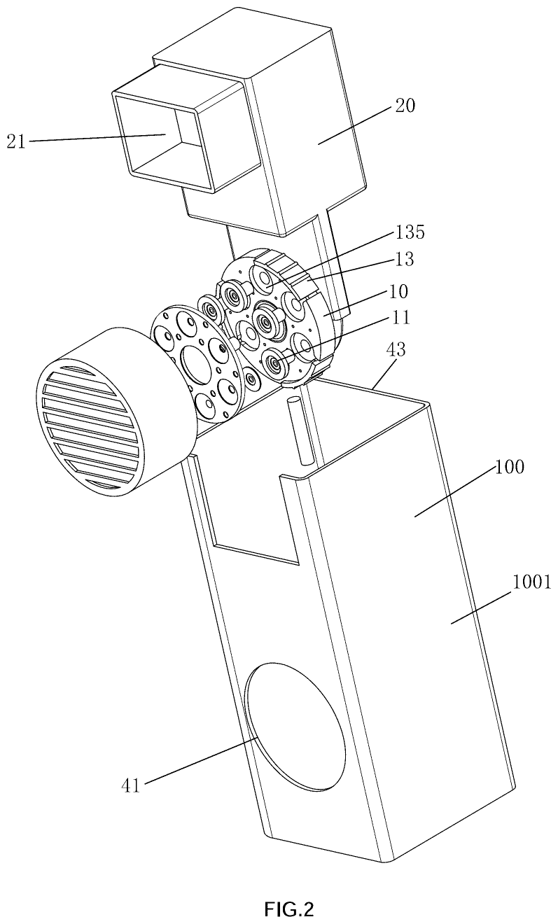

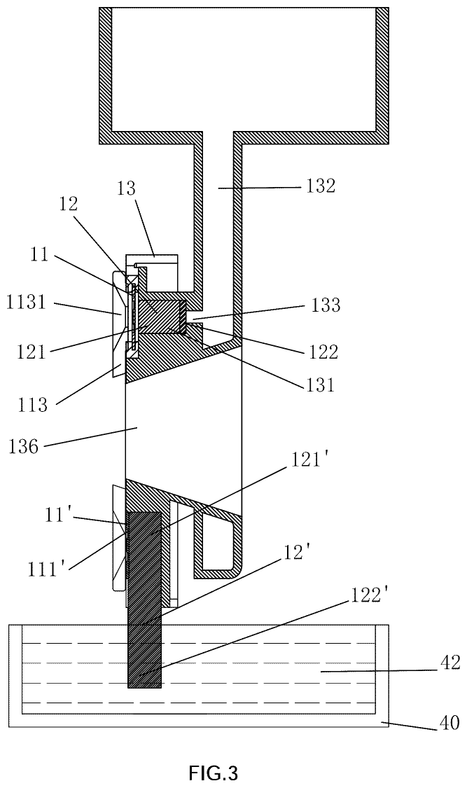

As shown in FIGS. 2 and 3, the housing 13 has one or more mounting grooves 135 on a side thereof, and each of the excitation units 11 is correspondingly sealed and installed in the mounting groove 135. Each of the excitation units 10 further comprises a guide chamber body 113, whose inner end is pressed against the impact piece 111 and the piezoelectric piece 112 to further play the role of sealing and installing the impact piece 111 and the piezoelectric piece 112 of the excitation unit 11, and the guide chamber body 113 is also installed in the mounting groove 135 and has a conical guide chamber 1131 to facilitate guiding water negative ions to leave the excitation mechanism 10.

In the present invention, the liquid stored in the liquid storage chamber body 20 is used to generate water anions, which can be various suitable liquid waters, such as drinking pure water, drinking conductive anion liquid and drinking mineral water, etc., and its conductivity is relatively weak, while the conductivity of the impact piece 111 is relatively strong, so that the impact piece 111 is more likely to lose charge, so that the vaporized tiny droplets are more likely to be charged and form water anions. The liquid storage chamber body 20 can be further provided with equipment for filtering and cleaning water, such as ultraviolet lamps, etc.

In order to make it easier for tiny droplets to carry charges and generate negative water ions, the size of the micropores 1113 arranged on the impact piece 111 is as small as possible and the number is as large as possible, so that the tiny droplets vibrate faster, and the friction between the impact piece 111 with a mesh structure and the tiny droplets is greater, so that the tiny droplets are more likely to carry negative charges.

In some specific examples, the impact piece 111 has a diameter of 10-20 mm, the central area 111 has a diameter of 1-10 mm, the number of micropores 1113 is 500-5000, and the pore size of the micropores 1113 is extremely small. In the present invention, the pore size of the micropores 1113 is less than 10 μm, and preferably the opening size is less than 5 μm. This is because the amount of water anions produced by the tiny droplets is positively correlated with the negative charge density, and the negative charge density depends on the contact time, contact area and charge density of the impact piece 111. Therefore, the smaller the size of the tiny droplets, the higher the average charge density, and the higher the amount of water anions produced. In other words, the smaller the diameter of the droplets, the easier it is to produce water anions, and the more concentrated the water anions are.

The micropores 1113 with extremely small aperture size in the present invention are used to control the size of the microdroplets generated by the excitation mechanism 10. In the present invention, the size of the microdroplets generated by the excitation mechanism 10 does not exceed 20 micrometers, so that the microdroplets are charged and generate water negative ions during the high-frequency vibration friction between the microdroplets and the impact piece 111 with a mesh structure.

In the present invention, the impact piece 111 may be a metal alloy such as a stainless steel sheet, which is punched to form the micropores 1113, thereby forming a mesh structure for contacting with water to vibrate and rub the water. For example, the impact piece 111 is a 316L stainless steel sheet, which is more likely to lose charge and be positively charged relative to the droplets. Of course, the impact piece 111 may also be a base inner layer including a stainless steel sheet and a material such as polyimide, aluminum or polyamide coated or attached to the outside of the base inner layer, which is more likely to lose charge and be positively charged relative to the droplets.

It is worth mentioning that in order to ensure that the water in contact with the electrical conductive material of the impact piece 111 can resonate to generate tiny droplets and in order to make the tiny droplets and the impact piece 111 have sufficient high-frequency friction, the voltage loaded on the piezoelectric piece 112 needs to be able to drive the impact piece 111 to vibrate at high frequency. Experimental data found that when the frequency loaded on the piezoelectric piece 112 is 110±KHz and the peak voltage is 60V-90V, the impact piece 111 can vibrate at high frequency and generate a high concentration of water anions, and the migration distance of the water anions is relatively long.

The air blowing mechanism 30 comprises a fan and one or more air filter layers, wherein the air filter layer is used to filter air, so that relatively clean air is sent to the excitation mechanism 10 by the fan. More specifically, the casing 40 also has an air inlet 43, wherein under the action of the fan, air enters the casing 40 from the air inlet 43 of the casing 40 and is filtered by the air filter layer, and then blows toward the excitation mechanism 10 and carries water negative ions forward to migrate and diffuse toward the front of the water anion excitation device.

It can be understood that in this embodiment of the present invention, the outlet 41 is located on the side of the water anion excitation device, that is, the water anion excitation device is a side wind outlet structure, so that the water negative ions formed by the excitation mechanism 10 migrate from the side of the water anion excitation device to the outside. In this way, because the water negative ions are charged tiny droplets, they are heavier than air, which is conducive to the migration of water negative ions over a longer distance when sprayed from the side.

It is understandable that the water anion excitation device of the present invention can naturally generate water negative ions by simulating the way a waterfall hits the ground, that is, by rubbing water at high frequency. The water negative ion concentration around the waterfall is 10,000-50,000/cm³. The water anion excitation device of the present invention can migrate negative ions to 200 cm, and the negative ion concentration within 200 cm can reach more than 30,000/cm³.

It can be understood that the present invention provides a method for preparing a water anion excitation device, which comprises the steps of assembling the excitation mechanism 10, assembling the excitation mechanism 10 with the liquid storage chamber body 20, and assembling the air blowing mechanism 30.

When assembling the excitation mechanism 10, a layer of the electrical conductive material is punched to form the impact piece 111 having the microholes 1113 in the central area 1111, and then the piezoelectric piece 112 is adhered to and electrically connected to the outer circumferential area 1112 of the impact piece 111 to form the excitation unit 11, and the piezoelectric piece 112 and the impact piece 111 are electrically connected to the power supply and the controller through wires, wherein the power supply is suitable for connecting to a commercial power supply to provide power supply. The elastic water absorbent body 12 is assembled in the accommodating channel 131 of the housing 13, and the excitation unit 11 is assembled in the mounting groove 135 of the housing 13 so that the impact piece 111 is aligned with the action end 121 of the elastic water absorbent body 12 in the accommodating channel 131, and the guide chamber body 113 is assembled on the outer side of the impact piece 111 so that the impact piece 111 is located between the guide chamber body 113 and the action end 121 of the elastic water absorbent body 12, and the guide chamber 1131 of the guide chamber body 113 is located in front of the impact piece 111. Preferably, the accommodating channel 131 and the elastic water absorbent body 12 are assembled in the horizontal direction. And a plurality of the excitation units 10 are arranged in the housing 13.

When the excitation mechanism 10 is assembled with the liquid storage chamber body 20, the accommodating channel 131 of the housing 13 is connected with the liquid storage chamber body 20. For example, the corresponding plurality of horizontally extending accommodating channels 131 are connected with the liquid storage chamber body 20 through a plurality of vertically extending guide channels 132, so that the liquid stored in the liquid storage cavity can enter the accommodating channel 131 through the guide channels 132 due to gravity and penetrate into the elastic water absorbent body.

When assembling the air blowing mechanism 30, the fan is assembled behind the excitation unit 10, and one or more air filter layers such as an air filter are arranged between the air inlet 43 of the casing 40 and the blower, so that the air entering the box body 40 is filtered by the air filter layer and then blown toward the excitation unit 10.

In addition, the excitation mechanism 10 of the present invention may also be arranged with a recovery liquid excitation unit 11′, which does not guide the liquid in the liquid storage chamber body 20 into the accommodating tank 131 through the guide channel 132, but arranges the recovery liquid elastic water absorbent body 12′ in a vertical direction so as to be able to guide the water in the liquid storage tank 42 of the box body 40 from the water-absorbing end 122′ upward to the action end 121′ and the position corresponds to the impact piece 111′, so that the impact piece 111′ vibrates and impacts the side of the action end 121′ of the recovery liquid elastic water absorbent body 12′ to generate water negative ions, so that the liquid will not accumulate in the liquid storage tank 42.

Accordingly, the water anion excitation device of the present invention is simple and convenient to operate when in use. Water, such as drinking pure water, drinking conductive negative ion liquid and drinking mineral water, is loaded into the liquid storage chamber body 20, and after the power supply is powered on and the controller is started, the exciting unit 11 is driven to make the impact piece 111 vibrate at a high frequency to impact the elastic water absorbing body 12, thereby automatically generating water negative ions.

Correspondingly, the present invention provides a method for generating negative water ions, wherein the impact piece 111 having the micropores 1113 vibrates and impacts the elastic water absorbent body 12 to generate tiny droplets, and the tiny droplets rub against the impact piece 111 to obtain negative charges to generate negative water ions, and the fan blows air to carry the generated negative water ions to migrate outward.

Accordingly, the impact piece 111 is driven to vibrate at a high frequency by connecting a voltage to the impact piece 111 and the piezoelectric piece 112. Preferably, the frequency of the voltage loaded on the impact piece 111 and the piezoelectric piece 112 is 3 KHz-5 MHz, and the peak value is 60V-90V.

The liquid in the liquid storage chamber body 20 is guided into the accommodating channel 131 extending transversely to the guide channel 132 through the guide channel 132, so that the liquid can penetrate into the elastic water absorbent body 12 filled in the accommodating channel 131.

The fan blows air toward the excitation mechanism 10 in a horizontal direction, and the air leaves the water anion excitation device from an outlet 41 on the side of the casing 40.

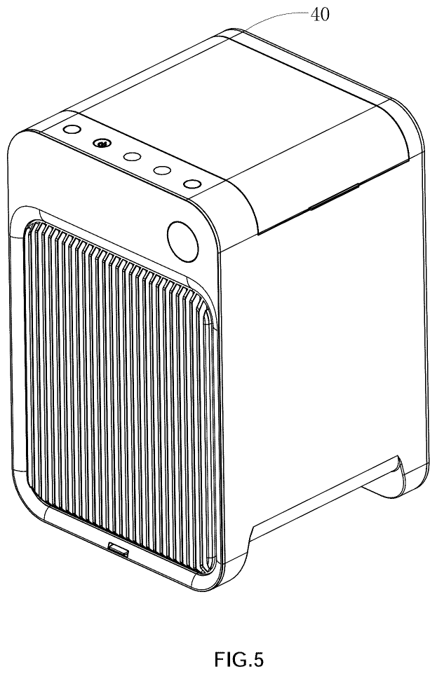

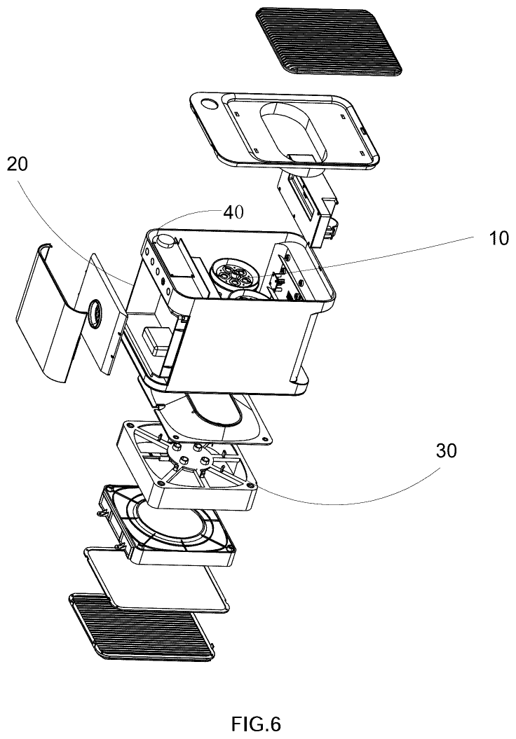

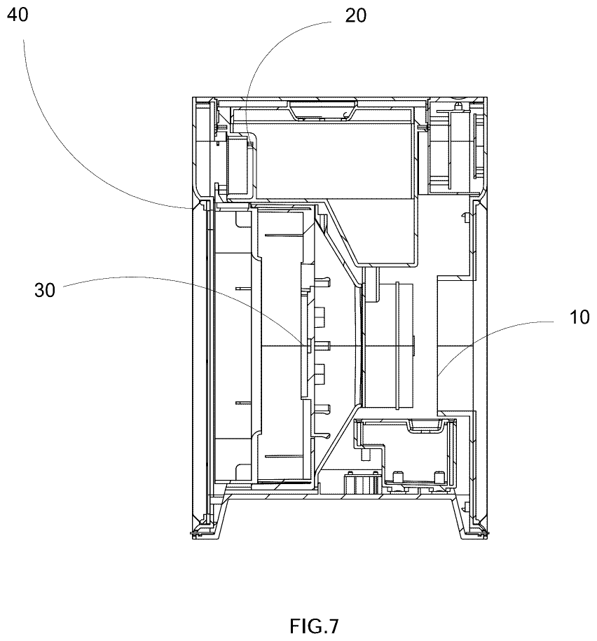

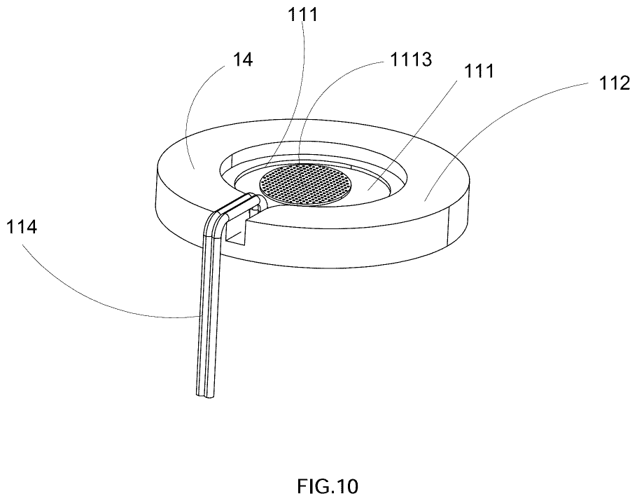

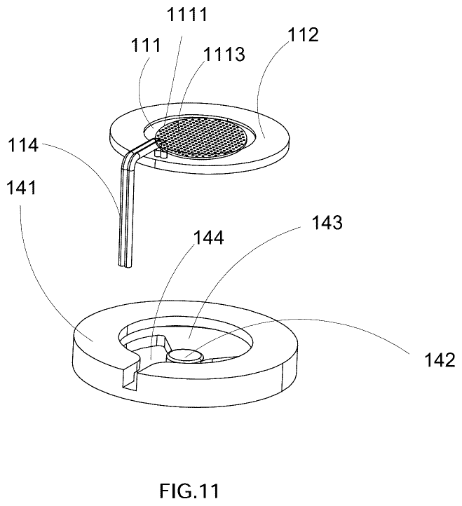

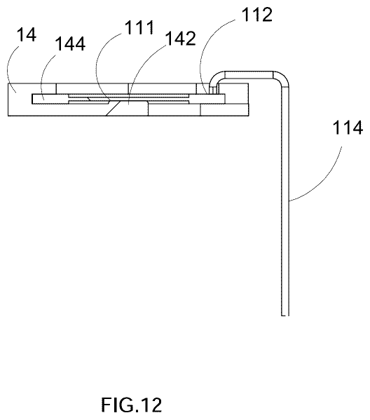

As shown in FIGS. 5 to 12, a water anion excitation device according to another embodiment of the present invention comprises an excitation mechanism 10, a liquid storage chamber body 20, an air blowing mechanism 30 and a casing 40, wherein the excitation mechanism 10, the liquid storage chamber body 20 and the blowing mechanism 30 are arranged in the casing 40, the liquid storage chamber body 20 is used to store liquid such as water, and the liquid storage chamber body 20 supplies liquid to the excitation mechanism 10 after filling water through a water feeding port 21 so that the liquid generates water negative ions when the excitation mechanism 10 works, and the blowing mechanism 30 blows the water negative ions generated by the excitation mechanism 10 to the outside of the water anion excitation device so that the water negative ions migrate and diffuse into the environment.

The excitation mechanism 10 comprises one or more excitation units 11, a housing 13, one or more elastic bodys 14, a power supply and a controller, wherein the housing 13 forms one or more accommodating grooves 131, and the accommodating grooves 131 are connected to the liquid storage chamber body 20, so that the liquid in the liquid storage chamber body 20 can enter the accommodating groove 131, and the excitation unit 11 can vibrate reciprocatingly at a high frequency when it is electrically connected to the controller and driven by the power supply to impact the liquid entering the accommodating groove 131, so that the liquid resonates and vaporizes to produce tiny droplets, and the tiny droplets rub against the excitation unit 11 to produce tiny droplets with electric charge to generate water negative ions.

In this embodiment, the excitation unit 11 comprises an impact piece 111 and at least one piezoelectric piece 112 attached to and electrically connected to the impact piece 111, wherein the piezoelectric piece 112 and the impact piece 111 are electrically connected to the controller and are powered and driven by the power supply, and the piezoelectric piece 112 and the impact piece 111 can be electrically connected to the controller respectively through two wires 114, or the piezoelectric piece 112 can be electrically connected to the controller through two wires 114. More specifically, the impact piece 111 has a central area 1111 and an outer circumferential area, wherein the piezoelectric piece 112 is a piezoelectric ceramic and is annular, which is attached to the outer circumferential area of the impact piece 111, and the central area 1111 of the impact piece 111 has a plurality of micropores 1113 to form a mesh structure.

The impact piece 111 is used to vibrate and impact and rub against the liquid in the accommodating channel 131, thereby generating negative ions. The corresponding elastic body 14 is arranged to fit the impact piece 111, so that when the impact piece 111 vibrates to generate water negative ions, it will also impact the elastic body 14, thereby avoiding the impact piece 111 from impacting the liquid and generating noise. More specifically, when a voltage with a predetermined frequency and peak value is applied to the piezoelectric piece 112 and the impact piece 111, the impact piece 111 will generate high-frequency vibration and hit the elastic body 14, thereby causing the liquid between the elastic body 14 and the impact piece 111 to resonate and generate tiny droplets, and while the tiny droplets are generated, they are rubbed with the impact piece 111 at a high frequency between the impact piece 111 and the elastic body 14, thereby further carrying negative charges to form water negative ions and diffusing from the micropores 1113 into the environment. The air blowing mechanism 30 blows out air and carries the negative water ions released from the micropores 1113 to diffuse to the external environment, so as to increase the migration distance of the negative water ions.

In addition, in another example, the piezoelectric piece 112 may be connected to both positive and negative electrodes, and when a voltage with a predetermined frequency and peak value is applied, the piezoelectric piece 112 vibrates to drive the impact piece 111 to vibrate.

Correspondingly, when the impact piece 111 is driven by the piezoelectric piece 112 to reciprocate, it simultaneously completes two processes to generate water negative ions, that is, the liquid between the elastic body 14 and the impact piece 111 is vaporized and charged, thereby efficiently generating water negative ions. In the present invention, when the excitation unit 11 vibrates at a high frequency, the water molecules between the elastic body 11 and the impact piece 11 are driven to resonate at the same frequency and vaporize to generate tiny droplets. At the same time, the generated tiny droplets rub against the high-frequency vibrating impact piece 111, so that the impact piece 111 loses its charge and the tiny droplets gain charge. The vaporized tiny droplets that gain charge thus form water negative ions such as negative water molecule groups containing H+: [H₃O₂—(H₂O)n], negative water molecule groups containing HO−: OH—(H₂O)n, negative water molecules containing —(H₂O)n, etc.

The housing 13 further comprises one or more guide channels 132 which are communicated to the liquid storage chamber body 20, wherein each of the accommodating channels 131 is communicated to the corresponding guide channel 132, and the accommodating channels 131 extend transversely to the corresponding guide channel 132, wherein each of the elastic bodies 14 is filled into the accommodating channels 131 to be consistent with the extension direction of the accommodating channels 131. For example, in this embodiment, each of the guide channels 132 is arranged in a vertical direction, and each of the accommodating channels 131 and the corresponding elastic body 14 are arranged in a horizontal direction.

The elastic body 14 is arranged at the end of the accommodating channel 131 facing the excitation unit 11, and is made of elastic material, such as elastic silicone or elastic rubber, and comprises an annular fixing plate 141, a buffering body 142 and a connector 143. The buffering body 142 extends inwardly and integrally through the connector 143 to the annular fixing plate 141. The excitation unit 11 is buried in the elastic body 14. The position of the buffering body 142 corresponds to the central area 1111 of the impact piece 111 having multiple micropores 1113, so that when the impact piece 111 vibrates at a high frequency, the central area 1111 having multiple micropores 1113 correspondingly impacts the buffering body 142, thereby buffering the vibration of the impact piece 111 and reducing the noise when hitting the liquid.

It is worth mentioning that the buffering body 142 is thinner than the annular fixing sheet 141 and is located in the inner cavity 144 of the annular fixing sheet 141 to be formed at the central position of the annular fixing sheet 141. The central area 1111 having a plurality of micropores 1113 is circular, and the buffering body 142 is also circular accordingly. When the buffering body 142 is hit, it is restricted to elastically vibrate in the inner cavity 144 to elastically buffer the central area 1111 of the impact piece 111, and at the same time allows the central area 1111 of the impact piece 111 to rub against the liquid so that the tiny droplets are charged to generate negative ion water mist.

It is understandable that in the above embodiment, the elastic water absorbent body 12 is implemented as a cotton column, and there is a risk that tiny bubbles will enter the cotton column in the accommodating channel 131, and the accumulation of tiny bubbles will cause the water path to be blocked in the cotton column, making it difficult for the liquid to pass through the cotton column and reach the position that interacts with the impact piece 111. In this embodiment of the present invention, the elastic body 14 is in the form of a sheet structure, which is overlapped with the impact piece 111 and is arranged at the end of the accommodating channel 131, so that the elastic body 14 will not cause the blockage of the water path, and can effectively produce elastic buffering for the impact piece 111 and reduce noise.

The housing 13 has one or more mounting grooves 135 on a side thereof, the elastic body 14 is installed in the corresponding mounting grooves 135, and each of the excitation units 11 is correspondingly sealed and installed on the outside of the elastic body 14 and located in the mounting grooves 135, and each of the excitation units 10 further comprises a guide chamber body 113, the inner end of which presses against the impact piece 111 and the piezoelectric piece 112 to further play the role of sealing and installing the impact piece 111 and the piezoelectric piece 112 of the excitation unit 11, so that the excitation unit 10 is maintained between the elastic body 14 and the guide chamber body 11. The guide chamber body 113 is also installed in the mounting groove 135 and has a conical guide chamber 1131 to facilitate guiding water negative ions to leave the excitation mechanism 10.

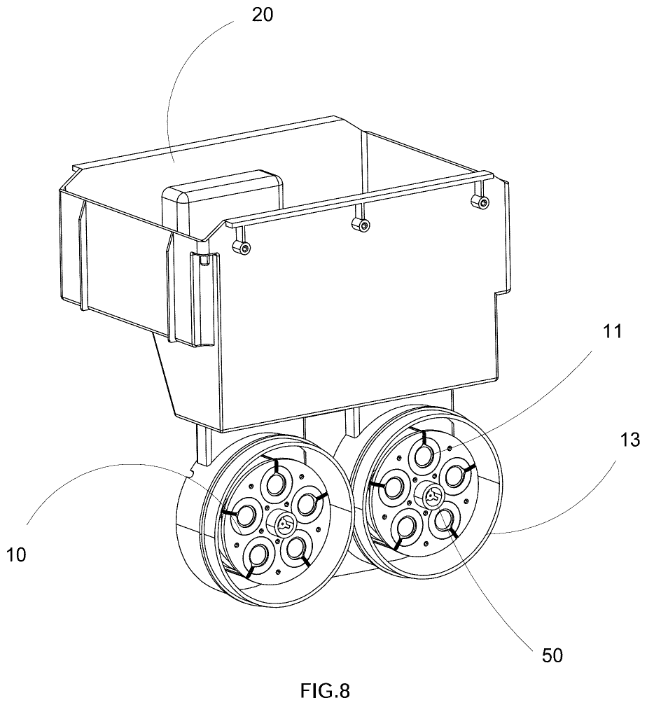

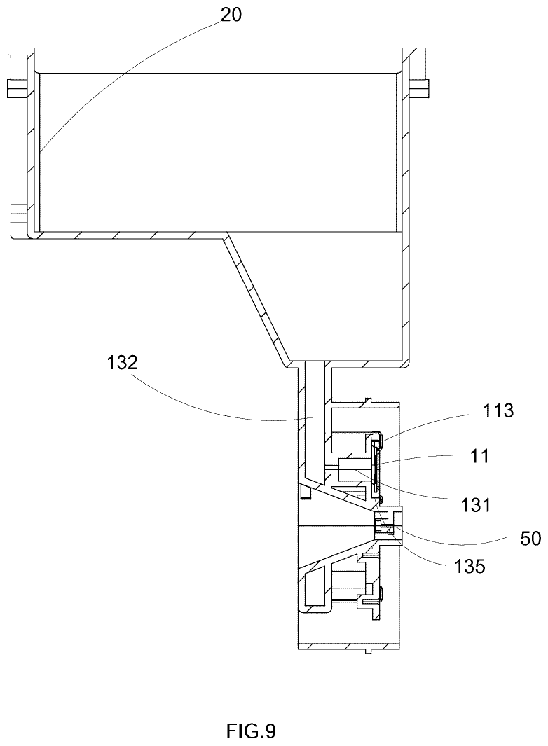

As shown in FIGS. 8 and 9, it is worth mentioning that the water anion excitation device may also comprise an electron charging device 50, which may comprise one or more charging needles and a boost circuit. The boost circuit increases the voltage to above 2 kv, preferably above −4 kv. The charging needle is electrically connected to the boost circuit to charge the water mist generated by the excitation unit 11, that is, the electrons generated by the charging needle are promptly absorbed by the water mist generated by the excitation unit 11, thereby generating negative ion water mist rich in negative ions.

The impact piece 111 of the water anion excitation device charges the atomized droplets based on friction charging, so that the negative charges generated by the electron charging device 50 are more easily adsorbed on the negative ion water mist, so that the concentration of negative charges adsorbed by water ions is higher and it is easier to saturate the negative charges. In other words, the negative ion water mist excitation device of the present invention not only atomizes the droplets, but also makes the atomized water mist itself carry negative ions, thereby forming a negative ion water mist, so that the negative ion water molecules are more likely to adsorb the negative charges supplemented by the electron charging device, so that compared with the charge of the atomized but uncharged droplets, the already charged negative ion water mist of the present invention is more likely to be supplemented with charges and charged to produce water negative ions with a higher negative ion concentration.

In the present invention, the impact piece 111 is driven by a voltage of a predetermined frequency and peak value to vibrate at a high frequency, and its center position is the center position where the liquid is converted into droplets, and a predetermined distance needs to be maintained between it and the electron charging device 50, that is, a predetermined distance needs to be maintained between the charging needle of the electron charging device 50 and the center position of the impact piece 111, so as to prevent the water mist droplets generated by the impact piece 111 from being attached to the charging needle due to the distance being too close, and also to prevent an arc from occurring between the charging needle and the impact piece 111, causing the charging needle to discharge high voltage to the entire water anion excitation device. The charging needle is made of corrosion-resistant material, preferably 316L stainless steel.

In the present invention, it is found according to experimental data that, preferably, the distance relationship between the position of the charging needle and the center position of the impact piece 111 is as follows:

When the working voltage of the charging needle is between −4 kv and −6 kv, the distance between the position of the charging needle and the center position of the impact piece 111 is greater than 10 mm.

When the working voltage of the charging needle is between −6 kv and −8 kv, the distance between the position of the charging needle and the center position of the impact piece 111 is greater than 15 mm.

When the working voltage of the charging needle is between −8 kv and −11 kv, the distance between the position of the charging needle and the center position of the impact piece 111 is greater than 20 mm.

Preferably, for example in a specific example, the distance between the position of the charging needle and the center position of the impact piece 111 can be selected to be 30 mm, and the voltage of the charging needle is preferably −10 kV.

In the example shown in FIG. 8, the water anion excitation device comprises a charging needle and a plurality of impact pieces 111 arranged in a circular direction, for example, five impact pieces 111 are arranged in a circumferential direction around the charging needle, so that the charging needle charges the water mist generated by the five impact pieces 111 around to form water negative ion mist. And preferably, as shown in FIG. 8, the distance between the center position of each impact piece 111 and the electron charging device 50 at the center is equal.

In this example, the connecting line of the center positions of the five impact pieces 111 can form a circle, that is, the five impact pieces 111 are arranged on a circle. In other variant embodiments, the connecting line of the center positions of the plurality of impact pieces 111 can form other shapes, such as a triangle, a hexagon, an octagon, etc., and the polygonal shape can be a regular polygon or an irregular polygon, and the plurality of impact pieces 111 surround a charging needle to capture and absorb the electrons ionized by the charging needle.

In addition, in the annularly arranged impact pieces 111 shown in FIG. 8, these impact pieces 111 can work together simultaneously to generate water mist, or can work alternately to generate water mist.

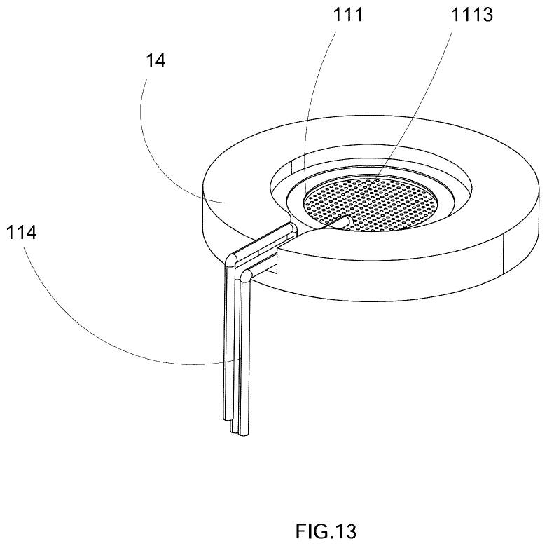

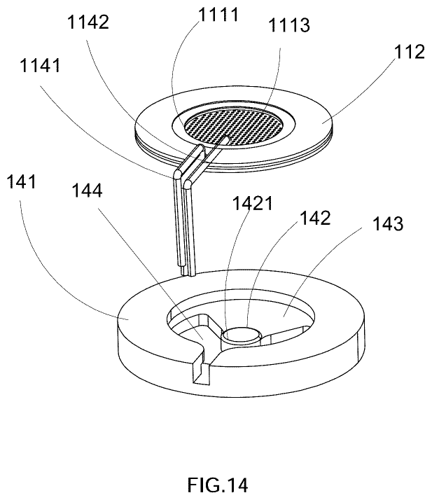

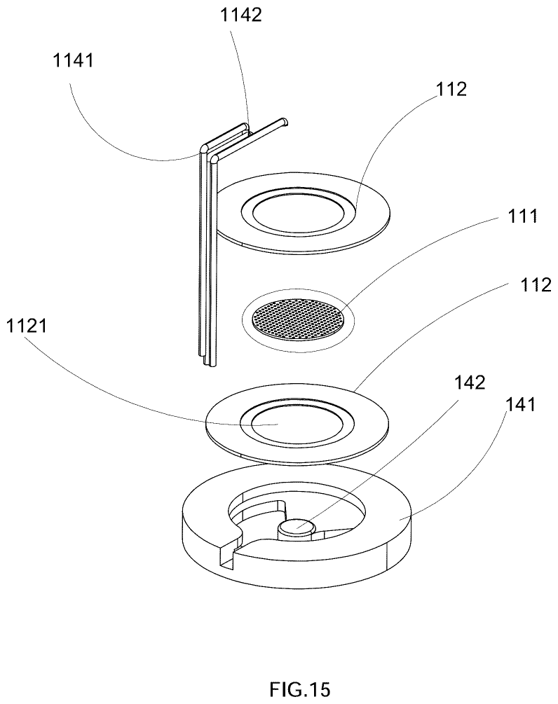

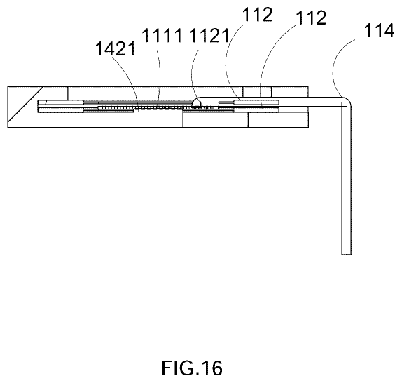

As shown in FIGS. 13 to 16, the excitation mechanism 10 of the water anion excitation device according to the modified implementation of another embodiment of the present invention comprises one or more excitation units 11, a housing 13, one or more elastic bodys 14, a power supply and a controller, wherein in this embodiment, the structures of the excitation unit 11 and the elastic body 14 are different from those in the above embodiment.

More specifically, in this embodiment, the excitation unit 11 comprises an impact piece 111 and two layers of piezoelectric pieces 112 adhered to and electrically connected to the impact piece 111, wherein the two layers of the piezoelectric pieces 112 and the impact piece 111 are electrically connected to the controller and are powered and driven by the power supply, the two piezoelectric pieces 112 and the impact piece 111 can be electrically connected to the controller respectively via three wires 114, and the impact piece 111 is located between the two layers of the piezoelectric pieces 1112.

The three wires 114 comprise two positive electrode wires 1141 and one negative electrode wire 1142. The two positive electrode wires 1141 are electrically connected to the two layers of the piezoelectric pieces 112 respectively, and the negative electrode wire 1142 is electrically connected to the impact piece 111. In this way, each of the piezoelectric pieces 112 and the impact piece 111 can respond to the input of the voltage signal so that the impact piece 111 will generate high-frequency vibration. It can be understood that the controller can drive one of the piezoelectric pieces 112 and the impact piece 111 to be in a working state while the remaining piezoelectric piece 112 does not work because there is no input voltage signal. In this way, by alternately connecting the excitation signal, the overall life of the excitation unit 11 becomes twice that of the excitation unit of a single-layer piezoelectric piece.

It is worth mentioning that each layer of the piezoelectric piece 112 can be electrically connected to the controller through two positive and negative wires, so that each excitation structure is powered on the same side, and the impact piece 111 is insulated from each layer of the piezoelectric piece 112. When an excitation signal is input into each layer of the piezoelectric piece 112, its vibration will drive the impact piece 111 to vibrate at a high frequency.

The impact piece 111 has a central area 1111 and an outer circumferential area, wherein the piezoelectric piece 112 is a piezoelectric ceramic and is ring-shaped, which is attached to the outer circumferential area of the impact piece 111, and the central area 1111 of the impact piece 111 has a plurality of micropores 1113 to form a mesh structure.

Similarly, the impact piece 111 is used to vibrate and impact and rub the liquid in the accommodating channel 131, thereby generating negative ions, and the corresponding elastic body 14 is arranged correspondingly to the impact piece 111, so that when the impact piece 111 vibrates to generate water negative ions, it simultaneously impacts the elastic body 14, thereby avoiding the impact piece 111 from impacting the liquid and generating noise. More specifically, when a voltage of a predetermined frequency and peak value is applied to the piezoelectric piece 112 and the impact piece 111, the impact piece 111 will generate high-frequency vibration and hit the elastic body 14, thereby causing the liquid between the elastic body 14 and the impact piece 111 to resonate and generate tiny droplets, and while the tiny droplets are generated, they are rubbed with the impact piece 111 at a high frequency between the impact piece 111 and the elastic body 14, thereby further carrying negative charges to form water negative ions and diffusing from the micropores 1113 into the environment. The air blowing mechanism 30 blows out air and carries the negative water ions released from the micropores 1113 to diffuse to the external environment, so as to increase the migration distance of the negative water ions.

The elastic body 14 is made of elastic material, such as elastic silicone or elastic rubber, and comprises an annular fixing plate 141, a buffering body 142 and a connector 143. The buffering body 142 extends inwardly and integrally through the connector 143 to the annular fixing plate 141. The excitation unit 11 is buried in the elastic body 14. The position of the buffering body 142 corresponds to the central area 1111 of the impact piece 111 having multiple micropores 1113. In this way, when the impact piece 111 vibrates at a high frequency, the central area 1111 having multiple micropores 1113 correspondingly impacts the buffering body 142, thereby buffering the vibration of the impact piece 111 and reducing the noise when hitting the liquid.

The buffering body 142 and the excitation mechanism 11 are located in the inner cavity 144 of the annular fixing plate 141. In this embodiment, the excitation mechanism 11 is formed with a groove 1121 by the annular piezoelectric piece 112 facing the buffering body 142, and the buffering body 142 is formed with a protrusion 141, which extends into the groove 1121, so that the protrusion 142 contacts the impact piece 111.

In this way, the central area 1111 of the impact piece 111 having a plurality of micropores 1113 contacts the protrusion 142 of the buffering body 142. When the protrusion 142 of the buffering body 142 is hit by the central area 1111 of the impact piece 111, it is restricted to elastically vibrate in the inner cavity 144 to elastically buffer the central area 1111 of the impact piece 111, and at the same time, the central area 1111 of the impact piece 111 is allowed to rub against the liquid so that the tiny droplets are charged to generate negative ion water mist.

The water anion excitation device of the present invention can generate high concentration of water negative ions. For example, in a specific example, the frequency loaded on the excitation unit 11 is 108 KHZ±2 kHz, the peak voltage is 70V±10V, the wind speed generated by the air blowing mechanism 30 is 3 m/s, the distance between the position of the charging needle and the center position of the excitation unit 11 is 30 mm, and the voltage of the charging needle is −10 kv, the negative ions can migrate to 200 cm, and the negative ion concentration within the range of 200 cm can reach 150,000 to 600,000/cm³; the negative ions can migrate to 400 cm, and the negative ion concentration within the range of 400 cm can reach 40,000 to 250,000/cm³.

The basic principles of the present application are described above in conjunction with specific embodiments. However, it should be noted that the advantages, strengths, effects, etc. mentioned in the present application are only examples and not limitations, and it cannot be considered that these advantages, strengths, effects, etc. are required by each embodiment of the present application. In addition, the above-disclosed specific details are only for the purpose of illustration and ease of understanding, not for limitation. The above details do not limit the present application to being implemented by adopting the above-mentioned specific details.

The block diagrams of the devices, apparatuses, equipment, and systems involved in this application are only illustrative examples and are not intended to require or imply that they must be connected, arranged, and configured in the manner shown in the block diagram. As will be appreciated by those skilled in the art, these devices, apparatuses, equipment, and systems can be connected, arranged, and configured in any manner. Words such as “including”, “comprising”, “having”, etc. are open words, referring to “including but not limited to”, and can be used interchangeably with them. The words “or” and “and” used here refer to the words “and/or” and can be used interchangeably with them, unless the context clearly indicates otherwise. The words “such as” used here refer to the phrase “such as but not limited to”, and can be used interchangeably with them.

It should also be noted that in the apparatus, device and method of the present application, each component or each step can be decomposed and/or recombined. Such decomposition and/or recombination should be regarded as equivalent solutions of the present application.

The above description of the disclosed aspects is provided to enable any person skilled in the art to make or use the present application. Various modifications to these aspects will be readily apparent to those skilled in the art, and the general principles defined herein may be applied to other aspects without departing from the scope of the present application. Therefore, the present application is not intended to be limited to the aspects shown herein, but rather to the widest scope consistent with the principles and novel features disclosed herein.

1-2. (canceled)

3. The water anion excitation device according to claim 2, A water anion excitation device, comprising:
an excitation mechanism comprising an excitation unit and an elastic body; and
a water storage chamber body, wherein a liquid stored in the water storage chamber body is suitable for being guided to the excitation unit, when the excitation unit impacts the elastic body, the excitation unit rubs against the liquid to generate water negative ions, wherein the elastic body is an elastic water absorbent body, wherein the liquid stored in the water storage chamber body is suitable for being absorbed into the elastic water absorbent body, and the excitation unit is used to impact the elastic water absorbent body to rub against the liquid in the elastic water absorbent body to generate the water negative ions, wherein the excitation mechanism further comprises a housing, wherein the housing has an accommodating channel which is communicated to the water storage chamber body, wherein the elastic water absorbing body is arranged in the accommodating channel;
wherein the housing further has a guide channel which is communicated to the accommodating channel, wherein the accommodating channel is extended transversely from the guide channel and is communicated to the water storage chamber body through the guide channel.

4. The water anion excitation device according to claim 3, further having a buffer channel formed between the accommodating channel and the guide channel.

5. The water anion excitation device according to claim 4, wherein an inner diameter of the buffer channel is smaller than an inner diameter of the accommodating channel, so as to prevent the elastic water absorbent body from entering the buffer channel.

6-10. (canceled)

11. A water anion excitation device, comprising:
an excitation mechanism comprising an excitation unit and an elastic body; and
a water storage chamber body, wherein a liquid stored in the water storage chamber body is suitable for being guided to the excitation unit, when the excitation unit impacts the elastic body, the excitation unit rubs against the liquid to generate water negative ions, wherein the excitation unit comprises a piezoelectric piece and an impact piece located on the piezoelectric piece, wherein the impact piece has micropores in a central region, and a pore size of the micropores is less than 10 μm.

12. The water anion excitation device according to claim 11, wherein the impact piece has a diameter of 10-20 mm, the central region having the micropores has a diameter of 1-10 mm, the number of the micropores is 500-5000, and the pore size of the micropores is less than 5 μm.

13. The water anion excitation device according to claim 12, wherein the impact piece is made of a material that loses charge more easily than water.

14. The water anion excitation device according to claim 13, wherein the impact piece is formed from a metal alloy.

15. The water anion excitation device according to claim 11, wherein the excitation unit is loaded with a voltage having a frequency of 3 KHz-5 MHz and a peak value of 60V-90V.

16. The water anion excitation device according to claim 11, wherein the excitation unit further comprises a guide chamber body arranged outside the impact piece, wherein the guide chamber body forms a conical guide chamber.

17-52. (canceled)
